(19) United States
(12) Patent Application Publication
(10) Pub. No.: US 2011/0146442 A1
(43) Pub. Date: Jun. 23, 2011

(54) COMPACT PEDAL UNIT

(75) Inventor: Jean-Marc Gobillard, Bures Sur Yvette (FR)

(73) Assignee: DREAMSLIDE, Bures sur Yvette (FR)

(21) Appl. No.: 13/059,098

(22) PCT Filed: Jul. 21, 2009
(86) PCT No.: PCT/FR09/51449

§ 371 Date: Feb. 15, 2011

(30) Foreign Application Priority Data
Aug. 20, 2008 (FR) 0855636

(51) Int. Cl. G05G 1/44

(52) U.S. Cl. 74/560

(57) ABSTRACT

A pedalling device, includes a drive shaft (2) passing through a frame, a right pedal (30), a left pedal (80), and a transmission mechanism, the transmission mechanism including for each pedal: a driving crank (3, 53), integral with the drive shaft (2); a coupling crank (27, 77); a transmission pivot (56) connecting the driving crank and the coupling crank; elements (4, 54, 55) for varying the distance between the axis of the transmission pivot and the axis of the drive shaft during the rotation of the shaft; a first and a second guide crank, each articulated to the frame; and two pedal pivots each connecting the pedal to one of the two guide cranks. The pedalling device is characterized in that, for each pedal, the coupling crank is integral with the first guide crank. Thus, the device obtained is very compact. Each coupling crank can also have a stabilizing role.

### TECHNICAL FIELD

The present invention relates to a pedalling device, in particular a pedalling device suited to a standing position of a user.

The field of the invention is more particularly that of wheeled vehicles powered by the pressure of the feet of a user, or that of static sports training devices, in particular the field of training devices or vehicles allowing a user to pedal while recreating natural movements similar to walking or running. In the remainder of this document the word “cycle” will be used to denote any wheeled vehicle powered by the pressure of the feet of a user, or any static sports training apparatus.

### STATE OF THE PRIOR ART

Document WO 2007/036 616 describes a pedalling device suited to a standing position of a user. However, certain pedal assembly embodiments described in this document have the drawback of a significant space requirement.

The purpose of the present invention is to propose a more compact pedalling device.

### DISCLOSURE OF THE INVENTION

This objective is achieved with a pedalling device comprising a drive shaft passing through a frame, a right pedal, a left pedal, and a transmission mechanism, the transmission mechanism comprising for each pedal:

a driving crank, integral with the drive shaft,

a coupling crank,

a transmission pivot connecting the driving crank and the coupling crank,

means of varying the distance between the axis of said transmission pivot and the axis of the drive shaft during the rotation of the shaft,

a first and a second guide crank, each articulated to the frame, and

two pedal pivots each connecting the pedal to one of the two guide cranks, characterized in that, for each pedal, the coupling crank is integral with the first guide crank.

In this document, the axis of a pivot is the axis of rotation about which at least one part connected to this pivot can turn, and the axis of a shaft is the axis of rotation about which this shaft can turn.

The pedalling device according to the invention can also comprise, for each pedal, means of stabilizing the first and second guide cranks. For each pedal, the stabilizing means can comprise a deformable parallelogram comprising the coupling crank. For each pedal, the deformable parallelogram of the stabilizing means can also comprise the transmission pivot, a linking connecting rod, a stabilizing pivot, a stabilizing crank, the transmission pivot connecting the coupling crank to the linking connecting rod, the stabilizing pivot connecting the linking connecting rod to the stabilizing crank. For each pedal, the stabilizing crank can be integral with the second guide crank. For each pedal, the coupling crank and the first guide crank can form a first constant angle, the stabilizing crank and the second guide crank can form a second constant angle, and the first and second constant angles can be approximately equal. For each pedal, the first and second constant angles can be approximately equal to ninety degrees.

Moreover, for each pedal, a minimum-stability position of the deformable parallelogram comprising the coupling crank can coincide with a maximum-stability position of a deformable parallelogram comprising the first and second guide cranks. Similarly, for each pedal, a maximum-stability position of the deformable parallelogram comprising the coupling crank can coincide with a minimum-stability position of a deformable parallelogram comprising the first and second guide cranks.

The frame can comprise a casing that surrounds the drive shaft, the driving cranks, the coupling cranks, the linking connecting rods and the stabilizing cranks; the guide cranks and the pedals can be situated outside the casing of the frame.

For each pedal, the length of the stabilizing crank can be approximately equal to the length of the first and the second guide crank divided by a ratio comprised between 3 and 4.

For each pedal, the length of the coupling crank can be approximately equal to the length of the first and the second guide crank divided by a ratio comprised between 3 and 4.

Furthermore, for each pedal, the axis of the drive shaft can be closer to the axis of a first frame pivot by which the first guide crank is articulated to the frame than to the axis of a second frame pivot by which the second guide crank is articulated to the frame.

Moreover, for each pedal, the axis of the drive shaft can be distinct from the axis of a first frame pivot by which the first guide crank is articulated to the frame and can be distinct from the axis of a second frame pivot by which the second guide crank is articulated to the frame.

In a first variant, the means of varying the distance can comprise for each pedal:

a groove along the driving crank, and

a roller that is free to move by rolling in the groove, and connected to the transmission pivot.

In another variant, the means of varying the distance can comprise means of varying the effective length of the driving cranks, such as a slide.

The transmission mechanism can be arranged in order to couple a rotation of the drive shaft about its axis to time-shifted movements of the right pedal and the left pedal. Furthermore, the transmission mechanism can be arranged in order that, for a constant speed of rotation of the drive shaft about its axis, the speeds of the pedals can be periodic with a period approximately equal to double the time shift between the right pedal and the left pedal.

Moreover, the transmission mechanism can be arranged in order to limit the movement of each pedal to a closed curved trajectory having a top part and a bottom part on either side of a plane in which the pedals are at an equal height, The transmission mechanism can be arranged in order to define for each pedal, for a constant speed of rotation of the drive shaft about its axis, a higher average speed in the top part than in the bottom part, such that the plane of equal height of the pedals is below the mid-height of the closed trajectories. Similarly, the transmission mechanism can be arranged in order that, for a constant speed of rotation of the drive shaft about its axis, the speed of each pedal is at its maximum in the top part and at its minimum in the bottom part, and the ratio of the maximum speed to the minimum speed of each pedal can be approximately comprised between two and three.

The height of each pedal is defined along a vertical axis, perpendicular to a horizontal axis. In this document, it is understood that the vertical axis is not necessarily parallel to the force of gravity. In fact, the orientation of the pedals can be maintained fixed relative to the frame, this vertical axis can be perpendicular to the ground on which this frame rests, regardless of the inclination of the ground relative to the force of gravity.

Finally, the pedalling device according to the invention can be incorporated into a static sports training device or a vehicle, said device or vehicle preferably being provided for a user in standing position on the pedals.

### DESCRIPTION OF THE FIGURES AND EMBODIMENTS

Other advantages and characteristics of the invention will become apparent on examination of the detailed description of implementations that are in no way limitative, and the attached drawings, in which:

FIG. 1 is an overall view of a preferred embodiment of a device according to the invention,

FIGS. 2 to 9 are profile views of the preferred embodiment of the device according to the invention, these views following one another in time as the drive shaft of the device rotates;

FIG. 6 corresponds to a profile view of FIG. 1, and FIG. 3 is enlarged for better visualization of the details.

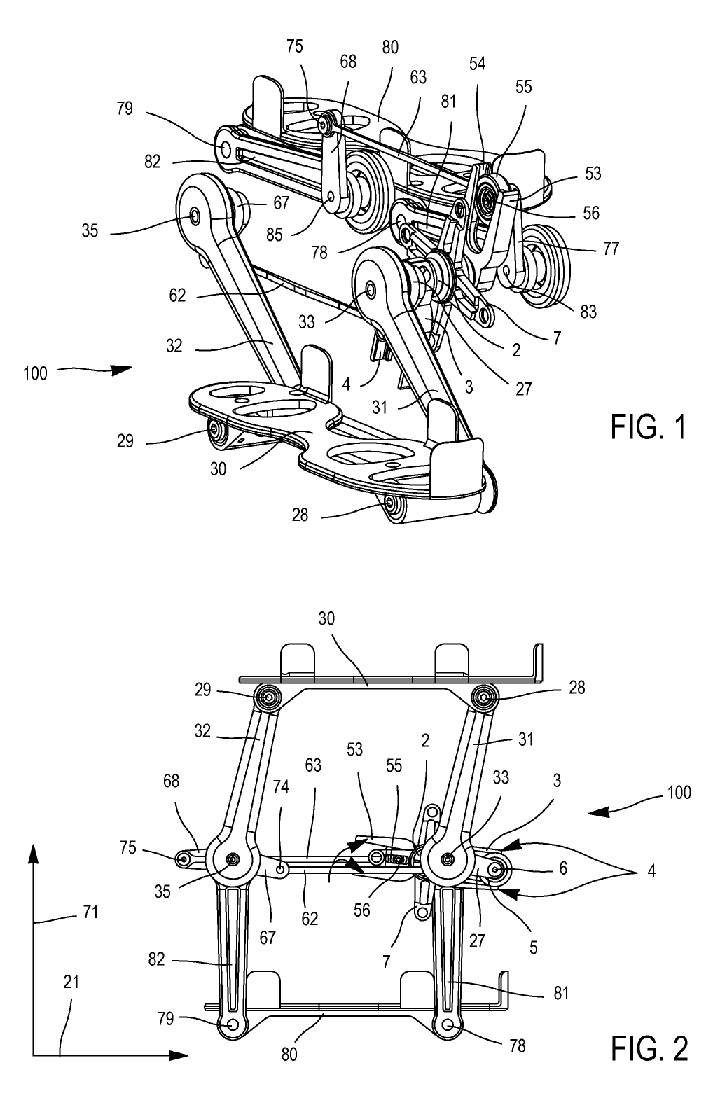

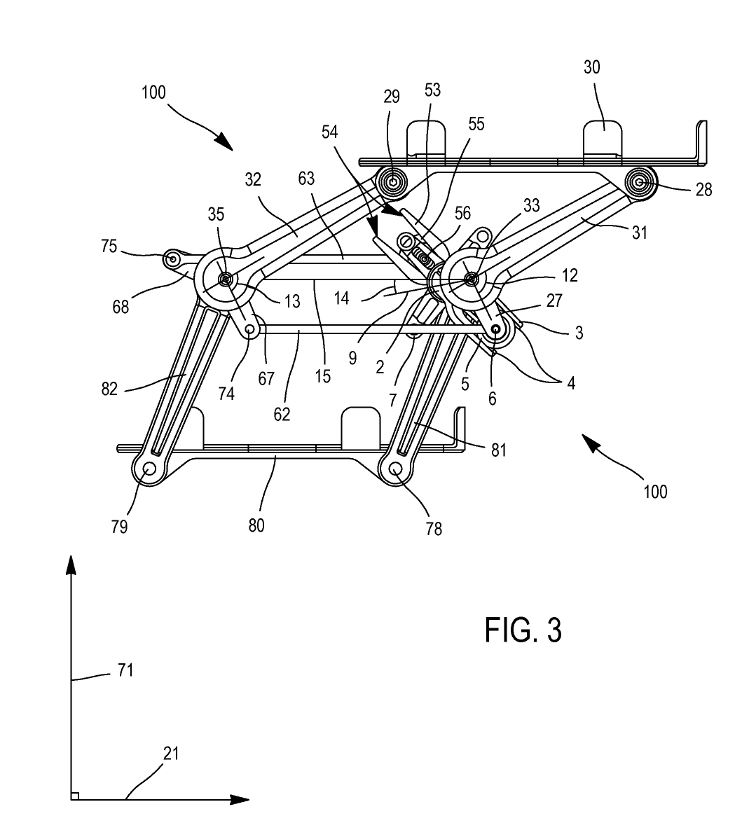

A description will now be given, with reference to FIGS. 1 to 9, of the preferred embodiment of a pedalling device (100) (or pedal assembly) according to the invention. The pedalling device 100 comprises a drive shaft 2 approximately perpendicular to the plane of FIGS. 2-9 formed by a horizontal axis 21 and a vertical axis 71, these two axes being perpendicular to each other. These axes 21, 71 are not shown in FIG. 1. The device 100 also comprises a right pedal 30 and a left pedal 80. The drive shaft 2 passes through a central part of a frame, not shown, and is free to turn about its axis 9 with respect to the frame. For this embodiment, the horizontal 21 is defined as the direction parallel to the pedals the orientation of which (i.e. the orientation of the plane along which a user's foot rests on the pedal 30 or 80) is maintained fixed relative to the frame, the vertical then not necessarily being parallel to the force of gravity. The vertical axis 71 acts as a support for a vertical scale defining the height of any object such as a pedal for example. The drive shaft 2 is integral, via a plate support 7, with a part such as a crown wheel or smooth ring, not shown in these figures, located inside the frame and making it possible to transmit via a chain, belt or shaft, a driving power generated by a rotation of the drive shaft 2 to any device consuming this power such as a rear wheel of a vehicle, or a system for dissipating the energy from a static sports training device. The device 100 is incorporated into this vehicle or this static sports training device which is not shown and which is provided for a user in a standing position on the pedals 30, 80.

The drive shaft is integral, on the right of the plane formed by the axes 21 and 71, with a right driving crank 3, and on the left of this plane with a left driving crank 53. The two driving cranks 3, 53 are approximately perpendicular to the drive shaft 2, and form between them an angle approximately equal to one hundred and eighty degrees. Thus, a rotation of the drive shaft 2 is integral with rotations of the driving cranks 3, 53.

The respectively right 3 or left 53 driving crank is connected to a respectively right 27 or left 77 coupling crank via a respectively right 6 or left 56 transmission pivot having an axis approximately parallel to the drive shaft 2. The left coupling crank 77 is visible only in FIG. 1. The two coupling cranks 27, 57 are approximately perpendicular to the drive shaft 2. This embodiment also comprises respectively right 4, 5, and left 54, 55 means of varying, during the rotation of the drive shaft 2, the distance between the axis of the respectively right 6 or left 56 transmission pivot and the axis of the drive shaft 2. These means of varying the distance comprise a respectively right 4 or left 54 longitudinal groove in which a respectively right 5 or left 55 roller rolls. This right 4 or left 54 longitudinal groove is produced along and inside the respectively right 3 or left 53 driving crank and is very slightly wider than the diameter of the respectively right 5 or left 55 roller, such that this roller is free to move along the length of the respectively right 4 or left 54 groove by rolling and resting alternatively on each of the two surfaces of this longitudinal groove without rubbing on the other face. Each roller possesses a surface rolling strip that can be convex or concave, and in this case the two surfaces of the associated longitudinal groove have a shape complementary to that of the roller such that the contact surface between one of the two surfaces of the longitudinal groove and the roller is always a convex or concave curved line and thus the roller cannot leave the longitudinal groove. The respectively right 5 or left 55 roller is connected to the respectively right 6 or left 56 transmission pivot and is free to turn about the axis of the respectively right 6 or left 56 transmission pivot. The connection between the roller 5 or 55 respectively and the transmission pivot 6 or 56 respectively can be made via a ball joint (not shown) that allows them to turn relative to one another even in the event that the axis of this transmission pivot is not wholly perpendicular to the driving crank 3 or 53 respectively.

The respectively right 30 or left 80 pedal is free to turn about the axis of a first respectively right 28 or left 78 pedal pivot and about the axis of a second respectively right 29 or left 79 pedal pivot. The axes of the pedal pivots 28, 29, 78, 79 are approximately parallel to the drive shaft. A first respectively right 31 or left 81 guide crank, separate from the drive shaft 2, is articulated to the frame by a first respectively right 33 or left 83 frame pivot and is free to turn about the axis of this first respectively right 33 or left 83 frame pivot. The axes of the frame pivots 33 and 83 being merged, the frame pivot 83 is visible only in FIG. 1. This first respectively right 33 or left 83 frame pivot is integral with the frame and possesses an axis approximately parallel to the drive shaft. The first respectively right 31 or left 81 guide crank is integral with the first respectively right 28 or left 78 pedal pivot and is approximately perpendicular to the axis of the drive shaft 2. The first pedal pivot 28 or 78 respectively connects the pedal 30 or 80 respectively to the first guide crank 31 or 81 respectively. The respectively right 27 or left 77 coupling crank is integral with the first respectively right 31 or left 81 guide crank and is integral with the respectively right 6 or left 56 transmission pivot. A second respectively right 32 or left 82 guide crank, separate from the drive shaft 2, is articulated to the frame by a second respectively right 35 or left 85 frame pivot and is free to turn about the axis of this second respectively right 35 or left 85 frame pivot. The axes of the frame pivots 35 and 85 being merged, the frame pivot 85 is visible only in FIG. 1. This second respectively right 35 or left 85 frame pivot is integral with the frame and possesses an axis approximately parallel to that of the drive shaft. The second respectively right 32 or left 82 guide crank is integral with the second respectively right 29 or left 79 pedal pivot and is approximately perpendicular to the drive shaft 2. The second pedal pivot 29 or 79 respectively connects the pedal 30 or 80 respectively to the second guide crank 32 or 82 respectively. Whatever the orientation of the frame in relation to the direction of the weight of a user, the pedals are maintained fixed in relation to the orientation of the frame by the guide cranks.

For each pedal 30 or 80 respectively, the axis 9 of the drive shaft 2 is distinct from the axis of the first frame pivot 33 or 83 respectively and from the axis of the second frame pivot 35 or 85 respectively. Moreover, the first frame pivots 33 and 83 have a common axis, and the second frame pivots 35 and 85 also have a common axis.

The role of the driving cranks 3, 53 is to transmit motive forces to the drive shaft. The role of the guide cranks 32, 82 is to guide the pedals in a circular movement. The role of the guide cranks 31, 81 is both to guide the pedals in a circular movement, and to transmit to the drive shaft 2 via the driving cranks 3, 53 motive forces originating from the pedals. The role of the coupling cranks 27, 77 is to couple the driving 3, 53 and guide 31, 32, 81, 82 cranks, and to transmit the motive forces to the driving cranks. The role of the longitudinal grooves is to vary the distance between the axes of the transmission pivots 6, 56 and the axis of the drive shaft 2. As will be seen below, each coupling crank 27, 77 also has a stabilizing role.

The successive states of the pedal assembly shown in FIGS. 2 to 9 follow on from one another when the drive shaft 2 makes slightly more than a half-turn clockwise in the course of FIGS. 2 to 9. It will be noted that the right 3 and left 53 driving cranks are never aligned with the guide cranks 31, 32, 81, 82.

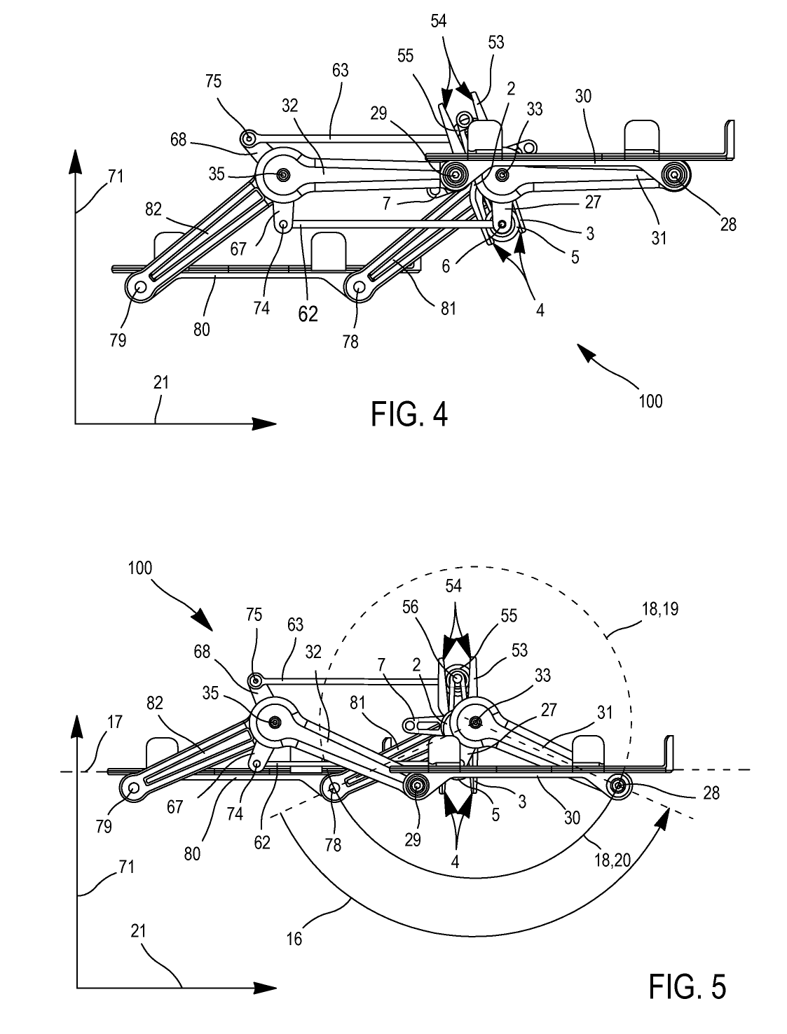

The deformable parallelogram constituted by the two right guide cranks 31 and 32, the two right frame pivots 33 and 35, the two right pedal pivots 28 and 29 and the right pedal 30 has unstable positions, like any deformable parallelogram, corresponding to the cases where the axes of the right frame pivots 33, 35 and the axes of the right pedal pivots 28, 29 are approximately aligned as illustrated in FIG. 4.

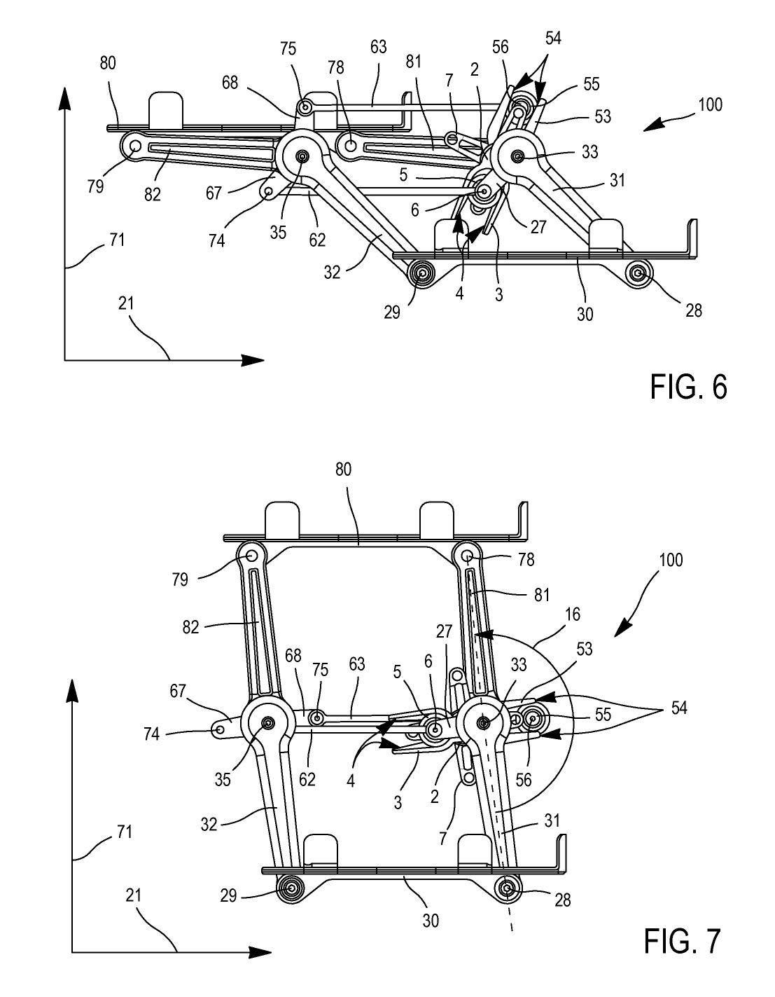

Similarly, the deformable parallelogram constituted by the two left guide cranks 81 and 82, the two left frame pivots 83 and 85, the two left pedal pivots 78 and 79 and the left pedal 80 has unstable positions, like any deformable parallelogram, corresponding to the cases where the axes of the left frame pivots 83, 85 and the axes of the left pedal pivots 78, 79 are aligned as illustrated in FIGS. 6 and 9.

The device 100 also comprises means of stabilizing the guide cranks 31, 32, 81, 82. These stabilizing means comprise the right coupling crank 27 and the left coupling crank 77, the right 6 and left 56 transmission pivot, a right linking connecting rod 62, a left linking connecting rod 63, a right stabilizing pivot 74 and a left stabilizing pivot 75, a right stabilizing crank 67 and a left stabilizing crank 68. The right 67 and left 68 stabilizing cranks and the right 62 and left 63 linking connecting rods are approximately perpendicular to the axis of the drive shaft 2.

The respectively right 67 or left 68 stabilizing crank is connected to and integral with the second respectively right 32 or left 82 guide crank, is approximately perpendicular to the axis of the drive shaft 2, and is integral with the respectively right 74 or left 75 stabilizing pivot the axis of which is approximately parallel to that of the drive shaft 2. The respectively right 74 or left 75 stabilizing pivot connects the respectively right 62 or left 63 linking connecting rod to the respectively right 67 or left 68 stabilizing crank. The respectively right 6 or left 56 transmission pivot connects the respectively right 27 or left 77 coupling crank to the respectively right 62 or left 63 linking connecting rod. The respectively right 62 or left 63 linking connecting rod is free to turn about the axis of the respectively right 6 or left 56 transmission pivot and about the axis of the respectively right 74 or left 75 stabilizing pivot. Thus, the right 27, 6, 62, 74, 67 and left 77, 56, 63, 75, 68 stabilizing means form two deformable parallelograms that stabilize all the respectively right 31, 81 and left 32, 82 guide cranks.

The respectively right 27 or left 77 coupling crank is integral with the first respectively right 31 or left 81 guide crank, such that the respectively right 27 or left 77 coupling crank and the first respectively right 31 or left 81 guide crank form a constant angle 12 approximately equal to 90 degrees. In other words, a straight line connecting the axis of the respectively right 6 or left 56 transmission pivot to the axis of the first respectively right 33 or left 83 frame pivot and a straight line connecting the axis of the first respectively right 33 or left 83 frame pivot to the axis of the first respectively right 28 or left 78 pedal pivot form a constant angle 12 approximately equal to 90 degrees.

Similarly, the respectively right 67 or left 68 stabilizing crank is integral with the second respectively right 32 or left 82 guide crank, such that the respectively right 67 or left 68 stabilizing crank and the second respectively right 32 or left 82 guide crank form a constant angle 13 approximately equal to 90 degrees. In other words, a straight line connecting the axis of the respectively right 74 or left 75 stabilizing pivot to the axis of the second respectively right 35 or left 85 frame pivot and a straight line connecting the axis of the second respectively right 35 or left 85 frame pivot to the axis of the second respectively right 29 or left 79 pedal pivot form a constant angle approximately equal to 90 degrees.

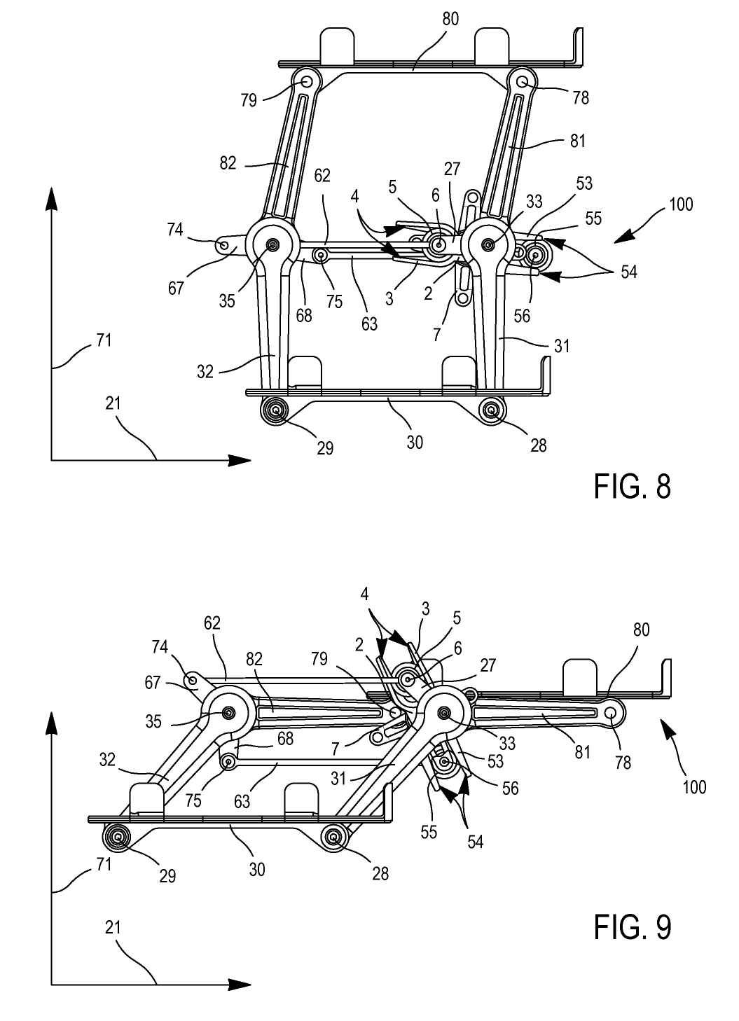

Thus:
the deformable parallelogram comprising the two right guide cranks 31 and 32, the two right frame pivots 33 and 35, the two right pedal pivots 28 and 29 and the right pedal 30 is in a minimum-stability position when the deformable parallelogram comprising the right coupling crank 27, the right transmission pivot 6, the right linking connecting rod 62, the right stabilizing pivot 74 and the right stabilizing crank 67 is in a maximum-stability position, as illustrated in FIG. 4,
the deformable parallelogram comprising the two right guide cranks 31 and 32, the two right frame pivots 33 and 35, the two right pedal pivots 28 and 29 and the right pedal 30 is in a maximum-stability position when the deformable parallelogram
   comprising the right coupling crank 27, the right transmission pivot 6, the right linking connecting rod 62, the right stabilizing pivot 74 and the right stabilizing crank 67 is in a minimum-stability position, as illustrated in FIG. 8,

the deformable parallelogram comprising the two left guide cranks 81 and 82, the two left frame pivots 83 and 85, the two left pedal pivots 78 and 79 and the left pedal 80 is in a minimum-stability position when the deformable parallelogram comprising the left coupling crank 77, the left transmission pivot 56, the left linking connecting rod 63, the left stabilizing pivot 75 and the left stabilizing crank 68 is in a maximum-stability position, as illustrated in FIGS. 6 and 9, and

the deformable parallelogram comprising the two left guide cranks 81 and 82, the two left frame pivots 83 and 85, the two left pedal pivots 78 and 79 and the left pedal 80 is in a maximum-stability position when the deformable parallelogram comprising the left coupling crank 77, the left transmission pivot 56, the left linking connecting rod 63, the left stabilizing pivot 75 and the left stabilizing crank 68 is in a minimum-stability position, as illustrated in FIG. 2.

The axis 9 of the drive shaft 2 is distinct from the axis of the first frame pivots 33, 83 and from the axis of the second frame pivots 35, 85.

As illustrated in FIGS. 1 to 9, the axes of the frame pivots 33, 35, 83 and 85 are all approximately contained in the same alignment plane 15 also comprising the horizontal direction 21. This plane 15 is perpendicular to the plane formed by the axes 21 and 71. It will be noted that the axis 9 of the drive shaft 2 is slightly offset downwards (i.e. towards the plane 17 in which the pedals are at an equal height) relative to this plane 15. The angle of displacement 14 between a straight line connecting the axis 9 of the drive shaft 2 to the axis of the first frame pivot 33 or 83 and a straight line connecting the axis of the first frame pivot 33 or 83 to the axis of the second frame pivot 35 or 85 is comprised between 0° and 20°, and is more precisely approximately equal to 10°. This angular displacement makes it possible to offset the upper dead centre of one pedal with respect to the lower dead centre of the other pedal.

In this document, the “upper dead centre” of a pedal refers to the highest position of this pedal along the vertical axis 71 during its trajectory, and the “lower dead centre” of a pedal refers to the lowest position of this pedal along the vertical axis 71 during its trajectory.

Moreover, it will be noted that the axis of the drive shaft is much closer to the axis of the first frame pivots 33, 83 than to the axis of the second frame pivots 35, 85, typically between 5 and 30 or more times closer. This dissymmetry makes the pedal assembly 100 very compact, as it makes it possible to bring the drive shaft 2 closer to the transmission pivots 6, 56.

Finally, the frame, not shown, comprises a metal casing that surrounds and encloses the drive shaft 2, the driving cranks 3, 53, the rollers 5, 55, the plate support 7, the coupling cranks 27, 77, the linking connecting rods 62, 63, and the stabilizing cranks 67, 68, such that only the guide cranks 31, 32, 81, 82 and the pedals 30, 80 are situated outside the casing of the frame.

The typical dimensions of the different elements composing the pedal assembly 100 are as follows:

the length of each guide crank 31, 32, 81, 82, i.e. the distance between the axis of the frame pivot 33, 35, 83, 85 respectively and the axis of the pedal pivot 28, 29, 78, 79 respectively is comprised between 120 mm (for a child) and 190 mm (for a very tall adult), and is more precisely approximately equal to 170 mm;

the length of each coupling crank 27, 77 and of each stabilizing crank 67, 68, i.e. the distance between the axis of the frame pivot 33, 35, 83, 85 respectively and the axis of the pivot 6, 74, 56, 75 respectively is approximately equal to the length of each guide crank divided by a miniaturization ratio comprised between 3 and 4; for a length of each guide crank equal to 170 mm and a miniaturization ratio equal to 3.4, the length of each crank 27, 77, 67, 68 is approximately equal to 50 mm;

the distance between the axis of the pivot 33, 83 respectively and the axis of the pivot 35, 85 respectively is greater than the length of each guide crank and is approximately equal to 220 mm;

the length of each linking connecting rod 62 or 63, i.e. the distance between the axis of the pivot 6 or 56 respectively and the axis of the pivot 74 or 75 respectively is approximately equal to the distance between the axis of the pivot 33 or 83 respectively and the axis of the pivot 35 or 85 respectively, and is therefore approximately equal to 220 mm;

the length of each pedal, i.e. the distance between the axis of the pedal pivot 29 or 79 respectively and the axis of the pedal pivot 28 or 78 respectively is approximately equal to the distance between the axes of the pivots 33 and 35 or between the axes of the pivots 83 and 85, and is therefore approximately equal to 220 mm;

the distance between the axis of the drive shaft 2 and the axis of the first frame pivots 33, 83 is approximately equal to 21 mm,

the maximum distance MAX between the axis of the drive shaft 2 and the axis of the transmission pivot 6 or 56 is equal to the length of each crank 27, 77, 67, 68 plus the distance between the axis of the drive shaft 2 and the axis of the first frame pivots 33, 83, i.e. 71 mm,

the minimum distance MIN between the axis of the drive shaft 2 and the axis of the transmission pivot 6 or 56 is equal to the length of each crank 27, 77, 67, 68 minus the distance between the axis of the drive shaft 2 and the axis of the first frame pivots 33, 83, i.e. 29 mm,

the projection along the horizontal axis 21 of the distance between the axis of the drive shaft 2 and the axis of the first frame pivots 33, 83 is approximately equal to 20.7 mm, and

the projection along the horizontal axis 21 of the distance between the axis of the drive shaft 2 and the axis of the second frame pivots 35, 85 is approximately equal to 199.3 mm.

In the particular case in which the angular rotation velocity of the drive shaft 2 about its axis is constant, the ratio of the maximum speed of a pedal to the minimum speed of this same pedal is comprised between two and three in order that the movement of the pedals is similar to a running movement, and is equal to MAX divided by MIN. Here, this ratio is approximately 2.45.

A height is defined for each pedal along the vertical axis 71. The vertical axis 71 is perpendicular to the horizontal axis. The horizontal axis is parallel to the plane of the pedals, and is also parallel to a straight line connecting the axes of the frame pivots 33, 35 or the axes of the frame pivots 83, 85, to a straight line connecting the axes of the pedal pivots 28, 29 or the axes of the pedal pivots 78, 79, to a straight line connecting the axis of the transmission pivot 6 to the axis of the stabilizing pivot 74 or further to a straight line connecting the axis of the transmission pivot 56 to the axis of the stabilizing pivot 75.

For each right 30 or left 80 pedal, the driving crank 3 or 53 respectively, the coupling crank 27 or 77 respectively, the transmission pivot 6 or 56 respectively, the roller 5 or 55 respectively, the groove 4 or 54 respectively, the guide cranks 31, 32 or 81, 82 respectively, the frame pivots 33, 35 or 83, 85 respectively and the pedal pivots 28, 29 or 78, 79 belong to a transmission mechanism.

The transmission mechanism is arranged in order to couple a rotation of the drive shaft 2 about its axis 9 to time-shifted movements of the right pedal 30 and the left pedal 80 according to a certain time shift. Moreover, the transmission mechanism is arranged in order that, for a constant speed of rotation of the drive shaft 2 about its axis 9, the speeds of the pedals are periodic, having a period approximately equal to double the time shift of the right pedal 30 and the left pedal 80.

Moreover, the transmission mechanism is arranged in order to limit the movement of each pedal to a closed curved trajectory 18 having a top part 19 (shown by dotted lines in FIG. 5) and a bottom part 20 (shown by solid lines in FIG. 5) on either side of the plane 17 in which the pedals are at an equal height. This plane 17 is perpendicular to the plane formed by the axes 21 and 71 and is illustrated in FIG. 5.

Thus, during the rotation of the drive shaft 2, the right pedal 30 and the left pedal 80 approximately describe the same curve as a circle 18. The closed curved trajectory 18 being a circle, it therefore has approximately equal horizontal and vertical dimensions. The circle 18 shown in FIG. 5 represents the trajectory of the axis of the first right pedal pivot 28 centred on the axis of the first frame pivot 33 and also represents the trajectory of the axis of the first left pedal pivot 78 centred on the axis of the first frame pivot 83. A position of the first right pedal pivot 28 on the circle 18 corresponds to a single position of the first left pedal pivot 78 on the circle 18.

The transmission mechanism is arranged in order that the angle 16 between a segment connecting the axis of the first right pedal pivot 28 to the centre 33, 83 of the circle 18 and a segment connecting the axis of the first left pedal pivot 78 to the centre 33, 83 of the circle varies during the movement of the pedals, and passes through its minimum when the pedals are approximately at the same height: this particular case is illustrated in FIG. 5. This angle variation allows for the reduction of the oscillation amplitude of the centre of gravity of a user in a standing position on this embodiment of a pedalling device according to the invention compared with a conventional pedal assembly. Thus, the movement of the user's legs is similar to the movement of walking or running.

The transmission mechanism is arranged in order to define for each pedal, for a constant speed of rotation of the drive shaft 2 about its axis 9, a higher average speed in the top part 19 than in the bottom part 20, such that the plane of equal height 17 of the pedals is below the mid-height of the trajectories 18.

Finally, the transmission mechanism is arranged in order that, for a constant speed of rotation of the drive shaft 2 about its axis 9, the speed of each pedal is at its maximum in the top part 19 and at its minimum in the bottom part 20, and in that the ratio of the maximum speed to the minimum speed of each pedal is approximately comprised between two and three.

With reference to FIG. 7, in the particular case in which the angular rotation velocity of the drive shaft 2 about its axis is constant:

one of the pedals reaches its maximum speed when the other pedal reaches its minimum speed, i.e. when the angle 16 is approximately equal to 180 degrees; for one revolution of the drive shaft, two positions exist for which the angle 16 is equal to 180 degrees;

the speed of a pedal is at its maximum close to the upper dead centre of this pedal, as illustrated for the left pedal in FIG. 7, which limits the effect of the upper dead centre, and means that in this position the lever arm of this pedal relative to the drive shaft is itself also at its maximum, and

the speed of a pedal is at its minimum close to the lower dead centre of this pedal, as illustrated for the right pedal in FIG. 7, which limits a dissipation at the lower dead centre of kinetic energy associated with the movement of the centre of gravity of a user and means that in this position the lever arm of this pedal in relation to the drive shaft is itself also at its minimum.

The highest position of each pedal on the trajectory 18 is further from the plane of equal height 17 than the lowest position of each pedal; in other words, the plane of equal height 17 of the pedals is situated below the mid-height of the trajectories of the pedals.

With reference to FIG. 2, when a pedal reaches its lower dead centre, the other pedal has already passed its upper dead centre.

Of course, the invention is not limited to the examples that have just been described, and numerous adjustments can be made to these examples without exceeding the scope of the invention. In particular, numerous variations can be envisaged as to the manner of varying the distance between the axes of the transmission pivots 6, 56 and the axis of the drive shaft 2 of a pedal assembly according to the invention. In the preceding description, the example was given of driving cranks that comprise a slide or a longitudinal groove inside which a roller bearing the transmission pivot slides. The case could also be envisaged in which each driving crank 3, 53 is made up of two parts, one sliding in the other such that the effective length of these driving cranks varies, such that the distance between the axes of the transmission pivots 6, 56 and the axis of the drive shaft 2 varies.

Finally, in the examples previously described, one pedal reaches its lower dead centre when the other pedal has passed its upper dead centre. In other embodiments, a pedal reaches its upper dead centre when the other pedal simultaneously reaches its lower dead centre, the speed of a pedal is at its maximum exactly at the level of the upper dead centre of this pedal, and the speed of a pedal is at its minimum exactly at the level of the lower dead centre of this pedal.

1. Pedalling device, comprising a drive shaft (2) passing through a frame, a right pedal (30), a left pedal (80), and a transmission mechanism, the transmission mechanism comprising for each pedal (30, 80):
a driving crank (3, 53), integral with the drive shaft (2),
a coupling crank (27, 77),
a transmission pivot (6, 56) connecting the driving crank and the coupling crank,
means (4, 5, 54, 55) of varying the distance between the axis of said transmission pivot (6, 56) and the axis of the drive shaft (2) during the rotation of the shaft.
a first and a second guide crank (31, 32, 81, 82), each articulated to the frame, and
two pedal pivots (28, 29, 78, 79) each connecting the pedal (30, 80) to one of the two guide cranks,
characterized in that, for each pedal, the coupling crank (27, 77) is integral with the first guide crank (31, 81).

2. Pedalling device according to claim 1, characterized in that it also comprises, for each pedal, means (33, 27, 6, 62, 74, 67, 35, 83, 77, 56, 63, 75, 68, 85) of stabilizing the first and second guide cranks (31, 32, 81, 82).

3. Pedalling device according to claim 2, characterized in that for each pedal, the stabilizing means comprise a deformable parallelogram comprising the coupling crank (27, 77).

4. Pedalling device according to claim 3, characterized in that for each pedal, the deformable parallelogram of the stabilizing means also comprises the transmission pivot (6, 56), a linking connecting rod (62, 63), a stabilizing pivot (74, 75), a stabilizing crank (67, 68), the transmission pivot connecting the coupling crank to the linking connecting rod, the stabilizing pivot connecting the linking connecting rod to the stabilizing crank.

5. Pedalling device according to claim 4, characterized in that for each pedal, the stabilizing crank is integral with the second guide crank.

6. Pedalling device according to claim 5, characterized in that for each pedal, the coupling crank (27, 77) and the first guide crank (31, 81) form a first constant angle (12), the stabilizing crank (67, 68) and the second guide crank (32, 82) form a second constant angle (13), the first and second constant angles being approximately equal.

7. Pedalling device according to claim 6, characterized in that for each pedal, the first and second constant angles are approximately equal to ninety degrees.

8. Pedalling device according to claim 3, characterized in that for each pedal, a minimum-stability position of the deformable parallelogram comprising the coupling crank (27, 77) coincides with a maximum-stability position of a deformable parallelogram comprising the first and second guide cranks (31, 32, 81, 82).

9. Pedalling device according to claim 3, characterized in that for each pedal, a maximum-stability position of the deformable parallelogram comprising the coupling crank (27, 77) coincides with a minimum-stability position of a deformable parallelogram comprising the first and second guide cranks (31, 32, 81, 82).

10. Pedalling device according to claim 4, characterized in that the frame comprises a casing that surrounds the drive shaft (2), the driving cranks (3, 53), the coupling cranks (27, 77), the linking connecting rods (62, 63), and the stabilizing cranks (67, 68), the guide cranks (31, 32, 81, 82) and the pedals (30, 80) being situated outside the casing of the frame.

11. Pedalling device according to claim 4, characterized in that for each pedal, the length of the stabilizing crank is approximately equal to the length of the first and second guide crank divided by a ratio comprised between 3 and 4.

12. Pedalling device according to claim 1, characterized in that for each pedal, the length of the coupling crank is approximately equal to the length of the first and second guide crank divided by a ratio comprised between 3 and 4.

13. Pedalling device according to claim 1, characterized in that for each pedal, the axis (9) of the drive shaft (2) is closer to the axis of a first frame pivot (33, 83) by which the first guide crank is articulated to the frame than to the axis of a second frame pivot (35, 85) by which the second guide crank is articulated to the frame.

14. Pedalling device according to claim 1, characterized in that for each pedal, the axis (9) of the drive shaft (2) is distinct from the axis of a first frame pivot (33, 83) by which the first guide crank is articulated to the frame and is distinct from the axis of a second frame pivot (35, 85) by which the second guide crank is articulated to the frame.

15. Pedalling device according to claim 1, characterized in that the means of varying the distance comprise for each pedal:
a groove (4, 54) along the driving crank (3, 53), and
a roller (5, 55) free to move by rolling in the groove, and connected to the transmission pivot (6, 56).

16. Pedalling device according to claim 1, characterized in that the means of varying the distance comprise means of varying the effective length of the driving cranks, such as a slide.

17. Pedalling device according to claim 1, characterized in that the transmission mechanism is arranged in order to couple a rotation of the drive shaft (2) about its axis (9) to time-shifted movements of the right pedal (30) and the left pedal (80).

18. Pedalling device according to claim 17, characterized in that the transmission mechanism is arranged in order that, for a constant speed of rotation of the drive shaft (2) about its axis (9), the speeds of the pedals are periodic with a period approximately equal to double the time shift between the right pedal (30) and the left pedal (80).

19. Pedalling device according to claim 1, characterized in that the transmission mechanism is arranged in order to limit the movement of each pedal to a closed curved trajectory (18) having a top part (19) and a bottom part (20) on either side of a plane (17) in which the pedals are at equal height.

20. Pedalling device according to claim 19, characterized in that the transmission mechanism is arranged in order to define for each pedal, for a constant speed of rotation of the drive shaft (2) about its axis (9), a higher average speed in the top part than in the bottom part, such that the plane of equal height of the pedals is below the mid-height of the closed trajectories.

21. Pedalling device according to claim 19, characterized in that the transmission mechanism is arranged in order that, for a constant speed of rotation of the drive shaft (2) about its axis (9), the speed of each pedal is at its maximum in the top part and at its minimum in the bottom part, and in that the ratio of the maximum speed to the minimum speed of each pedal is approximately comprised between two and three.

22. Pedalling device according to claim 1, characterized in that it is incorporated into a static sports training device or a vehicle provided for a user in a standing position on the pedals (30, 80).
